(19) United States
(12) Patent Application Publication
(10) Pub. No.: US 2018/0334957 A1
(43) Pub. Date: Nov. 22, 2018

(54) METHOD AND APPARATUS FOR OPERATING A GAS TURBINE USING WET COMBUSTION

(71) Applicant: Fraunhofer-Gesellschaft zur Foerderung der angewandten Forschung e. V., Munich (DE)

(72) Inventor: Ralf KRIEGEL, Kahla (DE)

(21) Appl. No.: 15/776,821

(22) PCT Filed: Nov. 17, 2016
(86) PCT No.: PCT/DE2016/100536

§ 371 Date: May 17, 2018

(30) Foreign Application Priority Data
Nov. 18, 2015 (DE) 102015119915.7

(51) Int. Cl. F02C 3/30; F02C 3/22; F02C 6/04; F02C 3/04; F04C 29/00; F04C 19/00; F23L 7/00; C01B 13/02

(52) U.S. Cl. CPC F02C 3/30; F02C 3/22; F02C 6/04; F02C 3/04; F04C 29/0085; F05D 2220/32; F23L 7/007; C01B 13/0251; F05D 2270/20; F05D 2270/16; F04C 19/00

(57) ABSTRACT

The aim of the invention is to significantly increase the electrical efficiency or the proportion of the effective work of gas turbines, even in small gas turbines or microsize gas turbines having a simple design. According to the invention, the drawbacks of the prior art are overcome using wet combustion with oxygen, the oxygen being supplied via mixed-conducting ceramic membranes. The driving force needed for the oxygen to penetrate is created by lowering the partial pressure of the oxygen on the permeate side of the membrane module (5), and the energy required therefor is taken from the process energy produced in the gas turbine process.

The invention relates to a method for operating gas turbines of small (micro gas turbine) and medium overall size using oxygen as oxidizing agent for the fuel, wherein the oxygen is generated via mixed-conducting ceramic MIEC (Mixed Ionic Electronic Conductor) membranes at a high temperature using the process energy produced in the gas turbine process.

The conventional production of oxygen is at present preferably performed by pressure swing adsorption (PSA), vacuum pressure swing adsorption (VPSA), or by cryogenic air separation (Linde® process). Large plants with throughputs of more than 5,000 Nm³ O₂/h achieve a specific energy consumption of approximately 0.4 kWh_{el.}/Nm³ O₂ (cryogenic) and 0.36 kWh_{el.}/Nm³ O₂ (VPSA), respectively. In the case of lesser requirements concerning the purity of the oxygen, cryogenic air separation plants allow a minimal energy consumption of approx. 0.33 kWh_{el.}/Nm³ O₂ to be achieved, but only at production rates of approx. 500 t O₂/h or 350,000 Nm³ O₂/h, respectively [Fu, C., Gundersen, T.: Energy 44 (2012), p. 60-68].

For small consumers requiring little oxygen, smaller PSA plants are usually employed which require a minimum of 0.9 kWh_{el.}/Nm³ O₂. The use of oxygen from cylinders or liquid tanks results in considerable expenditure for rental and transport. All in all, the operation of smaller gas turbines using oxygen is uneconomic, because the energy required for conventional oxygen production exceeds the increase in efficiency, or the high cost of delivery overcompensates the useful effect.

An alternative method for producing oxygen is based on a high-temperature membrane separation process. For this purpose, mixed-conducting ceramic membranes (MIEC—Mixed Ionic Electronic Conductor) are used which allow highly selective separation of oxygen. The transport of oxygen is based on the transport of oxide ions through the gas-tight ceramic material and the simultaneously occurring transport of electronic charge carriers (electrons or defect electrons). Since the 1980s, a great number of ceramic materials have been examined with regard to oxygen transport and other material properties.

The permeation of oxygen through an MIEC membrane can be described by the Wagner equation and is determined, above all, by the ambipolar conductivity of the material at operating temperature, the membrane thickness and the driving force. The latter results from the logarithmic ratio of the oxygen partial pressure in the feed gas (pₕ) to the oxygen partial pressure in the sweep gas (pₗ) or in the permeate. Hence, the oxygen flow through an MIEC membrane for a given material, a constant membrane thickness and a defined temperature is proportional to In(pₕ/pₗ). Accordingly, doubling pₕ on the feed gas side results in the same increase in oxygen flow as halving pₗ on the permeate or sweep gas side. In order to produce pure oxygen in technical membrane gas plants, the air may be accordingly compressed or the oxygen may be aspirated using a vacuum; of course, combined processes are also possible.

For industrial-scale, process-integrated MIEC membrane plants, air compression has been propagated so far because compressors are generally less expensive and more readily available than vacuum generators. However, such an overpressure membrane separation process requires compression of the entire air flow, so that considerable compression work has to be performed at first. If this compression energy of the compressed air is not recovered, the energy required to generate oxygen using MIEC membranes will exceed that of cryogenic air separation and of pressure swing adsorption (PSA). Therefore, the overpressure process typically includes recovery of the compression energy, after the membrane separation process, by decompression of the compressed, oxygen-depleted air via a turbine. In this context, a recovery of more than 80% is aimed for by arranging highly efficient compressors and turbines on a joint shaft.

In contrast to the overpressure process on the basis of MIEC membranes, the alternative vacuum membrane separation process does not require recovery of the compression energy, so that independent MIEC membrane plants which are not process-integrated can also achieve a competitive energy consumption compared to cryogenic air separation, PSA and VPSA [DE 10 2013 107 610 A1].

A thermodynamic examination of the gas turbine process shows that, for a defined fuel supply, its efficiency, i.e. the amount of effective work obtainable from the process, increases as the oxygen content of the combustion air increases. Moreover, combustion with pure oxygen may generate a concentrated CO₂ flow enabling sequestration [AT 409 162 B]. However, combustion with oxygen also considerably increases the combustion temperature, making technical implementation in the gas turbines, which are already subject to high thermal loads, significantly more difficult. Therefore, some of the CO₂ is circulated and steam is used to cool the combustion chamber. In combination with a steam turbine (combined cycle power plant), a gross electrical efficiency of 64% can be achieved, which is decreased, however, to a net efficiency of approx. 55% by the energy requirement for oxygen generation and oxygen compression [Jericha, H.; Sanz, W.; Göttlich, E.: Gasturbine mit CO₂-Rückhaltung—490 MW (Oxyfuel-System Graz Cycle).—in: VDI-Berichte Nr. 1965—Stationäre Gasturbinen im Fokus von Wirtschaftlichkeit, Sicherheit and Klimaschutz, Leverkusen, Nov. 21-22, 2006, p. 1-20]. Therefore, in order to assess the benefits of operating a gas turbine on oxygen, the energy input required to provide the oxygen must be accordingly compared to the increase in obtainable effective work and suitably considered.

As already pointed out, it is well-known that high combustion temperatures can be significantly decreased by steam injection or water injection (US 2009/0071648 A1). If in a pure gas turbine process without subsequent use of the waste heat in a steam turbine, the steam is generated by means of the waste heat of the waste gas from the process and the steam is thereby introduced already at overpressure into the combustion chamber of the gas turbine, efficiencies similar to the process in a combined cycle power plant (gas and steam power plant) will be achieved [Göke, S., Albin, E., Göckeler, K., Krüger, O., Schimek, S., Terhaar, S., Paschereit, C. O.: Ultra-wet combustion for high efficiency, low emission gas turbines. 6^{th} Intern. Conf. “The Future of Gas Turbine Technology”, paper ID 17, Oct. 17-18, 2012, Brussels, Belgium]. This allows the efficiency range of a combined cycle power plant to be achieved already by one single gas turbine without requiring any further, separate components such as a steam turbine or an ORC system.

This so-called “wet combustion” results in much better cooling of the turbine blades and of the combustion chamber by the introduced water vapor, which is comparatively cold (200-400° C.). As a result, the usual film cooling of the turbine blades by means of excess air can be largely dispensed with, the air flow of the compressor of the gas turbine and the required compression power decrease, the amount of effective work or the efficiency, respectively, increases, the latter typically by 15-20 percentage points.

Moreover, “wet combustion” leads to a significant decrease in NOₓ emissions. However, what turns out to be difficult in “wet combustion” using air is to achieve stable combustion, because flame propagation and ignition limits change considerably due to the high content of water vapor in the fuel/air mixture.

The combustion of fuels in mixtures of oxygen and water vapor, preserves the aforementioned benefits of “wet combustion”, on the one hand, and allows the combustion temperature to be kept sufficiently low, on the other hand, due to even higher steam contents. On the basis of the above, an additional advantage results from the fact that, compared to “wet combustion” using air, the combustion using oxygen produces a waste gas having a high CO₂ content and a high water vapor content, thus enabling CO₂ separation even in simple, small-scale gas turbines. Moreover, most of the water vapor contained in the flue gas can be condensed out and recycled to steam generation, so that additional water only has to be supplied to the process in order to equalize losses.

For these reasons, a concept of “wet combustion” of hydrogen with oxygen in a gas turbine is currently being pursued [media release 42/2015 of the Technical University of Berlin, dated Feb. 24, 2015]. The purpose is to generate hydrogen and oxygen by water electrolysis from surplus renewables-based power. Accordingly, the object of this development is to achieve intermediate storage of electrical energy from renewable sources (wind power, photovoltaics) in the form of compressed gases (H₂, O₂) and its reconversion by the gas turbine. However, water electrolysis requires at least 4 kWh of electrical energy per normal cubic meter of hydrogen, and as much as 8 kWh of electrical energy per normal cubic meter of oxygen; therefore, it does not appear to make any sense, under energetic aspects, to provide electrolytically generated oxygen for oxygen combustion of conventional fuels. Thus, the above-described approach is merely suitable for intermediate storage of surplus power.

However, if the energy consumption involved in providing the oxygen in accordance with the above-mentioned considerations can be drastically reduced already for the low gas flows of micro gas turbine, a corresponding useful effect will also result for the combustion of conventional fuels. Accordingly, process concepts for energy production using MIEC membranes for the process-integrated generation of oxygen have already been described several times.

The process concepts described so far, such as also disclosed, for example, in WO 2008/091158 A1, use compressed air to provide the driving force for oxygen separation. An overpressure membrane separation process requires compression of the entire air flow. Therefore, the majority of the compression energy spent must be recovered after the separation process by decompression of the compressed, oxygen-depleted air via a turbine. This means that the turbine is typically used primarily to recover the compression energy [U.S. Pat. No. 5,852,925 A]. Additional combustion of a fuel with the compressed, oxygen-depleted air flow may even cause additional energy to be generated, enabling the joint production of electrical energy and oxygen. However, this concept does not envisage combustion of the fuel with oxygen.

Novel power plant concepts for IGCC (Integrated Gasification Combined Cycle) power plants use oxygen for gasification of the fuel [WO 2009/106027 A2]. Therefore, is seems obvious to use MIEC membranes also in order to provide the oxygen required for fuel gasification [WO 2008/105982 A1].

The coupling of MIEC membranes and the use of oxygen generated for combustion in the combustion chamber of the gas turbine has already been suggested and energetically assessed [Kotowicz, J. Michalski, S.: Analysis of a gas turbine used in a high temperature membrane air separation unit. Scientific Journals Maritime University of Szczecin, 2012, 31 (103), p. 128-133]. According to the cited prior art, the proposed process is based on the compression of air in order to separate the oxygen via the MIEC membranes. Due to the high expenditure of compression energy, this process accordingly requires the use of the oxygen-depleted, compressed exhaust air in the turbine in order to recover the compression energy input. Despite the high efficiency of the turbo components used, i.e. 88% in the air compressor and 90% in the turbine, a drop in electrical efficiency of the total system from 35% to 29% results for this process. Accordingly, such a process only makes economic sense if the separation of CO₂ overcompensates economically for the drop in efficiency by the revenue from corresponding certificates.

In the prior art, therefore, the combustion of fuels in gas turbines with oxygen generated within the process, as opposed to simple combustion with air, always results in a decrease in the effective work obtainable from the overall system or in lower net efficiency, respectively. The reason for this is the energy input required for oxygen generation with MIEC membranes, because said oxygen generation, in the systems propagated so far, always takes place via an overpressure process. Obviously, in this case, the energy input required to provide the oxygen exceeds the efficiency of intensified combustion, despite the recovery of the compression energy and despite the use of highly efficient turbo components.

It is an object of the invention to find a way to significantly increase the electrical efficiency of small and medium-sized gas turbines.

According to the invention, this object is achieved in that the oxygen for wet combustion of the fuel via MIEC membranes is generated within the process, in particular in that the driving force for oxygen permeation through the MIEC membranes is not generated by overpressure on the air side, but by lowering the oxygen partial pressure on the permeate side of the MIEC membrane. This lowering of the oxygen partial pressure is achieved in that steam or a partial flow of the combustion gas or a mixture of both gases as a sweep gas is used on the membrane, or the oxygen partial pressure is removed by negative pressure, preferably using the waste heat from the gas turbine or a small amount of the kinetic energy of the turbine to circulate the sweep gas or to generate the negative pressure.

The object is also achieved by an apparatus for operating a gas turbine using wet combustion in that an oxygen generator is arranged upstream of the gas turbine and a steam generator is arranged downstream of the gas turbine. In this case, the oxygen generator is an MIEC (Mixed Ionic Electronic Conductor) membrane module having a heat exchanger and a blower arranged upstream thereof. According to the invention, the steam generator is composed of a superheater, an evaporator, a condensate collector and an air-cooled exhaust gas cooler. An advantageous embodiment consists in that the gas turbine comprises a compressor, a combustion chamber and a turbine which generates electricity, in that the compressor is connected to the membrane module via a liquid ring pump, in that the superheater has a connection to the the combustion chamber for introducing steam into the latter, wherein said introduction is performed in a controlled manner so as to maintain the usual operating temperature. In order to compensate for thermal losses, it is advantageous to provide heating of the membrane module by combustion of the combustion gas. Another advantage results from arranging a steam motor between the superheater and the combustion chamber to drive the liquid ring pump. Another improvement is achieved by additionally arranging in the gas turbine a first start-up valve, a second start-up valve and a hot gas fan. In this case, the first start-up valve is arranged upstream of the combustion chamber to let air flow into the latter and the second start-up valve is arranged between the turbine and the combustion chamber. The hot gas fan is driven by the turbine, so that part of the exhaust gas from the combustion chamber can be supplied to the membrane module as a hot gas stream of steam and CO₂ at a low oxygen partial pressure to act as a sweep gas.

The invention will be explained in more detail below with reference to exemplary embodiments. In the Figures:

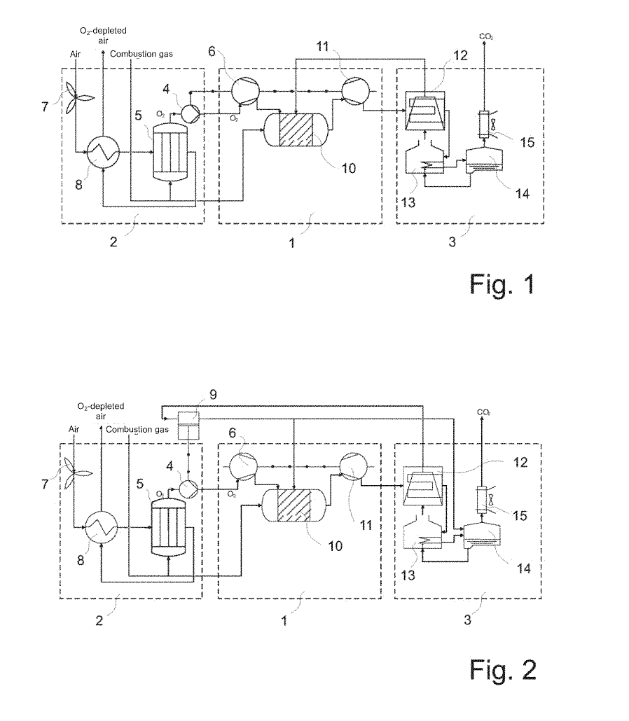

FIG. 1 is a process diagram showing the operation of a gas turbine using wet combustion, wherein the kinetic energy of the gas turbine is used for oxygen aspiration and compression;

FIG. 2 is a process diagram showing the operation of a gas turbine using wet combustion, wherein the driving force is generated from the waste heat of the gas turbine;

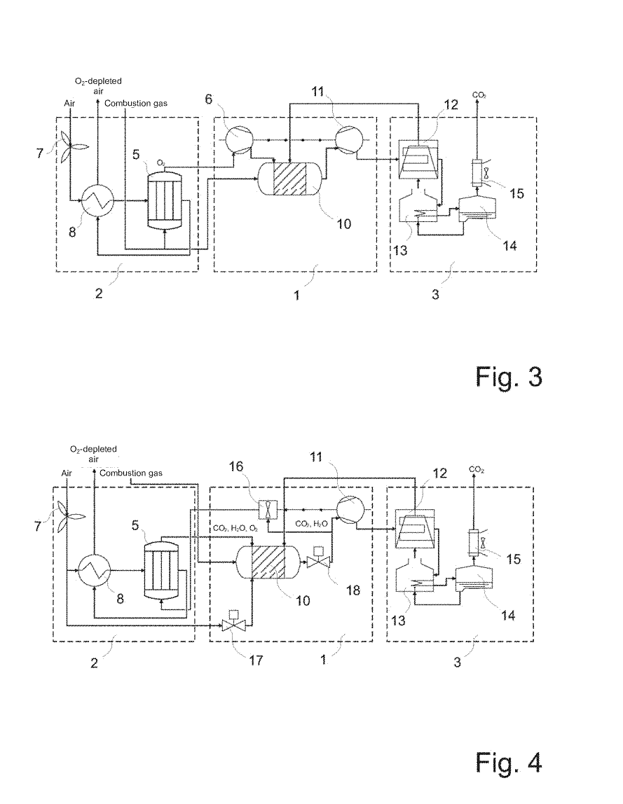

FIG. 3 is a process diagram showing the operation of a gas turbine using wet combustion in the oxygen/steam mixture and using oxygen generation by MIEC membranes, which are aspirated by an adapted compressor of the gas turbine, and

FIG. 4 is a process diagram showing the operation of a gas turbine using wet combustion by controlled circulation of a gas mixture of CO₂ and steam.

In a first exemplary embodiment, the principle of the method according to the invention will be explained with reference to FIG. 1. A conventional Capstone C50 micro gas turbine is used, which is schematically shown in FIG. 1 as a gas turbine 1 and has an electric efficiency of 28% when operated with air and a fuel consumption of 18 Nm³ of natural gas/h. The turbine is coupled with an oxygen generator 2 and a steam generator 3. The oxygen generator 2 is configured for an output of 36 Nm³ O₂/h. Fresh air is passed through the heat exchanger 8 and the adjacent membrane module 5 through a simple blower 7. Extraction of the oxygen is performed by a liquid ring pump 4 which removes the oxygen from the membrane module 5 and feeds it to the compressor 6 of the gas turbine 1. The compressor 6 of the gas turbine 1 compresses the oxygen exiting from the liquid ring pump 4 to approx. 5 bara (a—absolute) and pushes it into the combustion chamber 10 of the gas turbine 1. By varying the amount of steam entering the combustion chamber 10, the temperature in the latter is limited to the usual operating temperatures. The heating of the membrane module 5 required to compensate for thermal losses is effected by combustion of approx. 1 Nm³ of natural gas/h with the O₂-depleted air in the membrane module 5. The exhaust gas from the turbine 11 is used to generate steam by being supplied first to a superheater 12 and then to the evaporator 13. Thus, only a small part of the kinetic energy of the gas turbine 1 is used to generate the driving force for O₂ separation.

The exhaust gas flow is passed through the condensate collector 14 to the air-cooled exhaust gas cooler 15, which removes excess water by condensation and returns it to the cycle.

Wet combustion using oxygen increases the gross electrical efficiency of the conventional Capstone C50 micro gas turbine to 34%. The additional consumption of approx. 1 Nm³ of natural gas/h for heating the membrane module 5 and the resulting increase in overall gas consumption to approx. 19 Nm³ of natural gas/h result in a net electrical efficiency of 32% for the overall system. In addition to this increase in electrical efficiency from 28% to 32%, an exhaust gas flow of almost pure CO₂ is available, moreover, for recycling, and the waste heat can be used as before.

The basic design of the second exemplary embodiment corresponds to that of the first exemplary embodiment in its essential components. Again, a conventional Capstone 50 micro gas turbine is used as the gas turbine 1 and is coupled, according to FIG. 2, with an oxygen generator 2 and a steam generator 3. The oxygen generator 2 is configured for an output of 36 Nm³ O₂/h. Aspiration of the oxygen is again performed using a liquid ring pump 4 which removes the oxygen from the membrane module 5 and feeds it to the compressor 6 of the gas turbine 1. Fresh air is passed through the heat exchanger 8 and the membrane module 5 by a simple blower 7. The compressor 6 of the gas turbine 1 compresses the oxygen to approx. 5 bara (a—absolute). By varying the amount of steam, the temperature in the combustion chamber 10 is limited to the usual operating temperatures. The heating of the membrane module 5 required to compensate for thermal losses is effected by combustion of approx. 1 Nm³ of natural gas/h with the O₂-depleted air in the membrane module 5. The exhaust gas from the turbine 11 is used to generate steam by being supplied first to a superheater 12 and then to the evaporator 13. The resulting steam is used to operate the steam motor 9, which in turn drives the liquid ring pump 4. Thus, only the waste heat from the gas turbine 1 is used to generate the driving force for O₂ separation. The exhaust gas flow is passed through the condensate collector 14 to the air-cooled exhaust gas cooler 15, which removes excess water by condensation and returns it to the cycle.

Wet combustion using oxygen increases the gross electrical efficiency of the conventional Capstone C50 micro gas turbine to 41%. The additional consumption of approx. 1 Nm³ of natural gas/h for heating the membrane module 5 and the resulting increase in overall gas consumption to approx. 19 Nm³ of natural gas/h result in a net electrical efficiency of 39% for the overall system. In addition to this increase in electrical efficiency from 28% to 39%, an exhaust gas flow of nearly pure CO₂ is available, moreover, for recycling, and the waste heat can be used as before.

In the third exemplary embodiment, the gas turbine 1 used is a conventional Capstone C65 micro gas turbine whose compressor 6 has been re-fitted to compress oxygen from 0.09 bara (a—absolute) to 5 bara. In accordance with FIG. 3, fresh air is passed through the heat exchanger 8 and the membrane module 5 by a simple blower 7.

The compressor 6 of the gas turbine 1 compresses the oxygen entering at approx. 0.09 bara to approx. 5 bara. The entire exhaust gas flow from the turbine 11 with an exhaust heat of 126 kW is used to generate steam in the superheater 12 and in the evaporator 13. A steam pressure of >5 bara is achieved so that the steam can be introduced directly into the combustion chamber 10, where it is used to regulate the exhaust gas temperature. The heating of the membrane module 5 required to compensate for thermal losses is effected by combustion of approx. 1.4 Nm³ of natural gas/h with the O₂-depleted air in the membrane module 5. The exhaust gas flow is passed through the condensate collector 14 to the air-cooled exhaust gas cooler 15, which removes excess water by condensation and returns it to the cycle.

In combustion with air, the mass flow to be compressed, which flows through the gas turbine 1, is approx. 7 times greater than the mass flow of the pure oxygen from the oxygen generator 2. Accordingly, the compression work required in oxygen operation decreases to approximately 1/7. The mass flow through the turbine 11 also decreases, but is in turn increased by the additional steam mass flow through the combustion chamber 10. For this purpose, use is made only of the waste heat of the exhaust gas flow. In total, wet combustion with oxygen increases the gross electrical efficiency of the modified Capstone C65 micro gas turbine to 50%. The additional consumption of approx. 1.4 Nm³ of natural gas/h for heating the membrane module 5 and the resulting increase in overall gas consumption to approx. 24 Nm³ of natural gas/h result in a net electrical efficiency of 47% for the overall system. In addition to this increase in electrical efficiency from 29% to 47%, an exhaust gas flow of almost pure CO₂ is available, moreover, for recycling, and the waste heat can be used as before.

In the fourth exemplary embodiment, only the turbine part of a conventional Capstone C30 micro gas turbine is used as the gas turbine 1, because the compressor 6 has been removed, see FIG. 4. The turbine 11 drives a hot gas fan 16, which introduces part of the exhaust gas from the combustion chamber 10 as a hot gas stream of steam and CO₂ at a low oxygen partial pressure into the membrane module 5 as a sweep gas. The hot gas fan 16 requires substantially less energy than a compressor 6, which is usually part of a gas turbine 1, because the circulating gases need not be compressed. The gas turbine 1 is started up with an open first start-up valve 17 and an open second start-up valve 18, by initially operating the combustion chamber 10 with air as the oxidizing agent, until the membrane module 5 and the combustion chamber 10 have reached normal operating temperature. Next, the first start-up valve 17 and the second start-up valve 18 are closed. Since the continuous further addition of combustion gas keeps the oxygen partial pressure in the circulating partial exhaust gas flow low, oxygen in the membrane module 5 passes from the air into the exhaust gas flow, thereby oxidizing the added combustion gas. This results in a gradual pressure increase up to the operating pressure of 5 bara. Upon reaching this pressure, the exhaust gas is conducted onto the turbine 11 and expanded via the latter. The entire exhaust gas flow from the turbine 11 with an exhaust heat of 68 kW is used to generate steam in the superheater 12 and in the evaporator 13. A steam pressure of >5 bara is achieved so that the steam can be introduced directly, without subsequent compression, into the combustion chamber 10, where it is used to regulate the temperature. Compensation of thermal losses of the membrane module 5 is effected via the circulating partial exhaust gas flow. The exhaust gas flow is passed through the condensate collector 14 to the air-cooled exhaust gas cooler 15, which removes excess water by condensation and returns it to the cycle.

After start-up, the gas turbine 1 in this fourth exemplary embodiment requires no energy, during normal operation, for air or oxygen compression, because the oxygen automatically enters the circulating partial exhaust gas flow. Therefore, compared to the previous exemplary embodiments, there is a further overall increase in efficiency, i.e. in the part of the effective work obtainable from the system, to 65%. Again, an exhaust gas flow of nearly pure CO₂ is available for recycling.

### LIST OF REFERENCE NUMERALS

1 gas turbine

2 oxygen generator

3 steam generator

4 liquid ring pump

5 membrane module

6 compressor (of the gas turbine 1)

7 blower

8 heat exchanger

9 steam motor

10 combustion chamber

11 turbine

12 superheater

13 evaporator

14 condensate collector

15 exhaust gas cooler

16 hot gas fan

17 first start-up valve

18 second start-up valve

1.-7. (canceled)

8. A method for operating a gas turbine using wet combustion of a fuel with oxygen or oxygen-enriched air, wherein the oxygen needed for combustion is provided by a mixed-conducting ceramic MIEC (Mixed Ionic Electronic Conductor) membrane, by lowering an oxygen partial pressure on a permeate side of the MIEC membrane and all components involved in an operation of the gas turbine forming an overall system, the oxygen partial pressure on the permeate side of the MIEC membrane being lowered by process energy of the gas turbine to thereby increase an electrical efficiency of the overall system by at least 4 percentage points compared to a normal operation of the gas turbine with air.

9. The method of claim 8, wherein waste heat from the gas turbine is used for aspiration of the oxygen from the membrane.

10. The method of claim 8, wherein a compressor of the gas turbine is configured as a vacuum compressor which aspirates the oxygen from a membrane module at pressures below 160 mbar (absolute) and compresses the oxygen to an operating pressure of the gas turbine.

11. The method of claim 8, wherein an over-pressurized, i.e. compressed, partial gas flow of CO₂, steam, or a mixture thereof is used as a sweep gas at low oxygen partial pressure on the mixed-conducting membrane to thereby obviate any mechanical gas compression using electrical energy or mechanical work.

12. An apparatus for operating a gas turbine using wet combustion, wherein the apparatus comprises an oxygen generator arranged upstream of the gas turbine and a steam generator arranged downstream of the gas turbine, the oxygen generator comprising an MIEC membrane module having a heat exchanger and a blower arranged upstream thereof, and the steam generator comprising a superheater, an evaporator, a condensate collector and an air-cooled exhaust gas cooler, and wherein
the gas turbine comprises a compressor, a combustion chamber, and a power-generating turbine,
the compressor is connected to the membrane module via a liquid ring pump,
the superheater has a connection with the combustion chamber for introducing steam into the combustion chamber in a controlled manner so as to maintain a usual operating temperature, and
the membrane module is heated to compensate for thermal losses.

13. The apparatus of claim 12, wherein a steam motor driving the liquid ring pump is arranged between the superheater and the combustion chamber.

14. An apparatus for operating a gas turbine using wet combustion, wherein an oxygen generator comprising an MIEC membrane module having a heat exchanger and a blower arranged upstream thereof is arranged upstream of the gas turbine, and a steam generator comprising a superheater, an evaporator, a condensate collector and an air-cooled exhaust gas cooler is arranged downstream of the gas turbine, and wherein the gas turbine comprises a compressor, a combustion chamber, a power-generating turbine, a first start-up valve, a second start-up valve and a hot gas fan, the first start-up valve being arranged upstream of the combustion chamber to allow air to flow into the combustion chamber, the second start-up valve being arranged between the power-generating turbine and the combustion chamber, and the hot gas fan being driven by the power-generating turbine so that part of an exhaust gas from the combustion chamber can be fed as a hot gas flow of steam and CO₂ at a low oxygen partial pressure to the membrane module to act as a sweep gas.
